(19) United States
(12) Patent Application Publication
(10) Pub. No.: US 2012/0113106 A1
(43) Pub. Date: May 10, 2012

(54) METHOD AND APPARATUS FOR GENERATING FACE AVATAR

(75) Inventors: Yoon-Seok CHOI, Daejeon (KR); Ji Hyung Lee, Daejeon (KR)

(73) Assignee: Electronics and Telecommunications Research Institute, Daejeon (KR)

(21) Appl. No.: 13/288,698

(22) Filed: Nov. 3, 2011

(30) Foreign Application Priority Data
Nov. 4, 2010 (KR) 10-2010-0109283

(51) Int. Cl. G06T 17/00

(52) U.S. Cl. 345/419

(57) ABSTRACT

A face avatar generating apparatus includes: a face feature information extraction unit for receiving a face photo and extracting face feature information from the face photo and a two-dimensional (2D) avatar generation unit for selecting at least one region from the face photo based on the face feature information, and exaggerating or beautifying the selected region to create a 2D avatar image. The apparatus further includes a 3D avatar generation unit for modifying a standard 3D face model through a comparison with the standard 3D model based on the face feature information and pre-stored standard information to create a 3D avatar image.

### CROSS-REFERENCE(S) TO RELATED APPLICATION

The present invention claims priority of Korean Patent Application No. 10-2010-0109283, filed on Nov. 4, 2010, which is incorporated herein by reference.

### FIELD OF THE INVENTION

The present invention relates to a generation of particular two-dimensional (2D) and 3D avatars for a target face by using a face photo, and more particularly, to a method and apparatus capable of automatically generating a personal 2D avatar having artistic effects added thereto and a 3D face avatar having a 3D effect based on face feature points extracted from a face photo.

### BACKGROUND OF THE INVENTION

In the recent IT field, developments in the Internet and cellular phone technology and the market thereof have been rapidly expanded, and very recently, the general trend in the IT field is the wireless Internet and a smart phone.

As users are aware of the Internet as another world rather than a space for simply acquiring information, internet use has been gradually increased. In the internet world, users have started to use alter egos representative of users themselves, i.e., avatars. In the early Internet, an ID represented in text on a chatting window represented user oneself, but with development of a hardware and a network infrastructure, interest in visual elements become increased. Accordingly, an avatar such as a photo or a 3D model has been used. Indeed, a user selects one of several models provided in advance by a game developer in a game space and variously changes the selected model as a user's taste to use the model as user's own avatar. However, such model-based avatar should be selected within predetermined patterns, which means that the user owns a duplication pattern with another person.

Many existing Internet sites provide services similar to the above-mentioned services. For example, Facebook, which is a popular social network service, provides many flash-based cyberspace games, but avatars provided therefrom are merely on the level of a face made by combining a hair color, a shape of eyes, a head shape, or the like.

Another Internet service as cyber service, i.e., Second Life or Lively of Google, provides a 3D based cyberspace service. However, avatars provided from such service are also provided to be created by combining several feature information based on model information provided by a service provider. That is, an avatar service reflecting user's own individuality cannot be supported. As a result, a pretty model as being viewed can be used, but it is inevitable that a twin equally resembling user's avatar exists in any cyberspace.

Currently, as users can use the Internet in the cyberspaces thereof everywhere through a combination of a mobile Internet with a smart phone, the use frequency of an avatar that serves to be user's agent is increased and at the same time, user's desire required to have an avatar reflecting user's individuality rather than to have a model different from the user's looking is increased together.

Consequently, there is a great need for an avatar generating technology that can be easily used in various program environments while responding to people's needs for an avatar to which various effects can be applied and which has a difference from others.

### SUMMARY OF THE INVENTION

Therefore, the present invention provides a method and apparatus for generating a face avatar, which are capable of expressing various and particular egos in cyberspace by supporting a method of generating an avatar suitably representing personal characteristics depending on user's personal taste and allowing a user to appropriately generate a 2D avatar and a 3D avatar depending on the user's personal characteristics and activity space to use them.

In accordance with an aspect of the present invention, there is provided a face avatar generating apparatus including: a face feature information extraction unit for receiving a face photo and extracting face feature information from the face photo; a two-dimensional (2D) avatar generation unit for selecting at least one region from the face photo based on the face feature information, and exaggerating or beautifying the selected region to create a 2D avatar image; and a 3D avatar generation unit for modifying a standard 3D face model through a comparison with the standard 3D model based on the face feature information and pre-stored standard information to create a 3D avatar image.

In accordance with another aspect of the present invention, there is provided a face avatar generating method including: correcting geometrical information or color information of a face photo received from an outside and extracting face feature information based on the corrected result; selecting at least one region from the face photo based on the face feature information, and exaggerating or beautifying the selected region to create a 2D avatar image; and modifying a standard 3D face model through a comparison with the standard 3D model based on the face feature information and pre-stored standard information to create a 3D avatar image.

### BRIEF DESCRIPTION OF THE DRAWINGS

The objects and features of the present invention will become apparent from the following description of embodiments, given in conjunction with the accompanying drawings, in which:

FIG. 1 illustrates a block diagram of a face avatar generating apparatus in accordance with an embodiment of the present invention;

FIGS. 2A to 2D are views for explaining an operation in which geometrical information on a photo is corrected to automatically extract face feature information;

FIGS. 3A to 3C are views for explaining a process in which feature points of a face are extracted;

FIGS. 4A to 4C are views to which exaggeration and beautification are applied to an input photo by using the extracted features;

FIG. 5 is a view showing an image converted by applying artistic effects to the exaggerated and beautified image;

FIG. 6 is a view showing maximum/minimum face models of eight feature portions used for modifying a 3D face model;

FIG. 7A is a view showing predetermined eight portions marked for face feature and modification to generate a 3D avatar;

FIG. 7B is a view showing a 3D model to which the marked portions of FIG. 7A are projected as it is;

FIG. 8 is a view showing a process in which a texture is automatically generated based on the modified 3D face model;

FIG. 9 is a view showing a process in which a standard 3D face model input based on features of an input photo is modified to create a 3D face model and a texture and then a 3D avatar is generated by using the created the 3D face model and texture; and

FIG. 10 is a view showing a process in which an exaggerated image is generated from an input photo, and a 3D mesh is modified based on the generated exaggeration image to generate a 3D avatar.

### DETAILED DESCRIPTION OF THE EMBODIMENT

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram.

Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, an embodiment of the present invention will be described in detail with reference to the accompanying drawings.

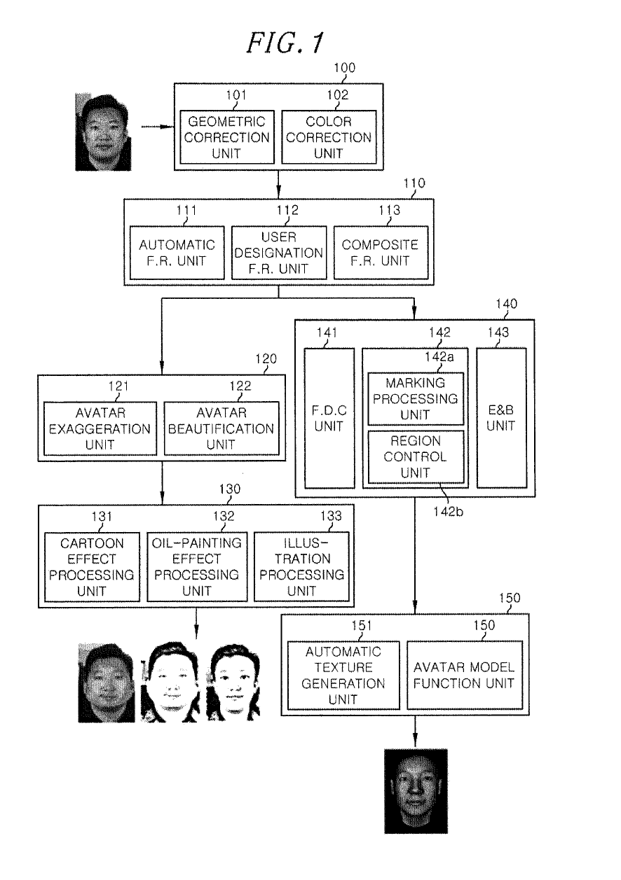

FIG. 1 illustrates a block diagram of a face avatar generating apparatus in accordance with an embodiment of the present invention.

Referring to FIG. 1, the inventive face avatar generating apparatus includes a data processing unit 100, a face feature information extraction unit 110, a 2D avatar generation unit 120, an artistic effect generation unit 130, a 3D avatar generation unit 140, a 3D avatar utilizing unit 150 and the like.

Since data for an avatar generation provided by users, e.g., face photo data, are different from one another in terms of the size of the photo data, a face position thereon, color and the like, it is not appropriate to extract feature information on a user's face from the photo data. Therefore, the data processing unit 100 performs a data processing on the photo data. In other words, the data processing unit 100 performs pre-processing to extract only a desired portion from the entire photo data or facilitate to extract feature points of a face by rotating the photo. To this end, the data processing unit 100 includes a geometric correction unit 101 for correcting geometric information of the photo data, a color correction unit 102 for correcting color in the photo data.

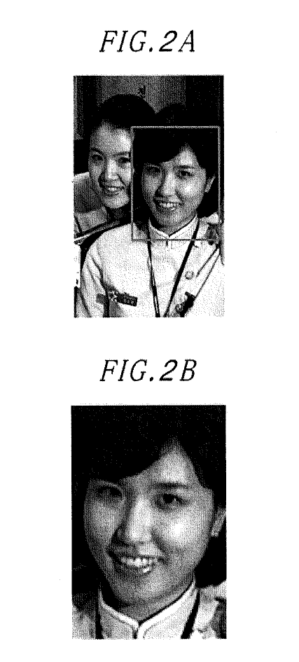

The geometric correction unit 101 extracts a desired portion shown in FIG. 2B from the photo data shown in FIG. 2A, or corrects photo data shown in FIG. 2C to obtain data shown in FIG. 2D of which face is rotated by the correction.

The face feature information extraction unit 110 extracts result data from the pre-processing performed by the data processing unit 100, namely, extracts face feature information from input photos provided after performing the pre-processing. To this end, the face feature information extraction unit 110 includes an automatic feature recognition unit (AUTOMATIC F.R. UNIT) 111, a user designation feature recognition unit (USER DESIGNATION F.R. UNIT) 112, a composite feature recognition unit (COMPOSITE F.R. UNIT) 113 and the like.

The automatic feature recognition unit 111 includes a machine learning module for recognizing eyes, a nose, a mouth, a jaw, or the like on a face based on a machine learning technique, and extracts feature information on the face by using the machine learning module.

The user designation feature recognition unit 112 extracts the feature information on the face from the input photos based on the feature information input from the user.

The composite feature recognition unit 113 provides an interface through which the user can directly correct the feature information extracted from the automatic feature recognition unit 111, and extracts the feature information on the face by using feature information corrected through the interface.

In the embodiment of the present invention, the feature information of the face is extracted from any one of the automatic feature recognition unit 111, the user designation feature recognition unit 112 and the composite feature recognition unit 113, or a combination thereof. For example, since the automatic feature recognition unit 111 requires a high computation performance due to the use of the machine learning module, it may not be suitable for portable devices such as a smart phone. In this case, the user designation feature recognition unit 112 is used to extract the feature information of the face, or the automatic feature recognition unit 111 may be installed in a server (not shown) that can be connected to a smart phone to extract face feature information of an input photo provided from the smart phone.

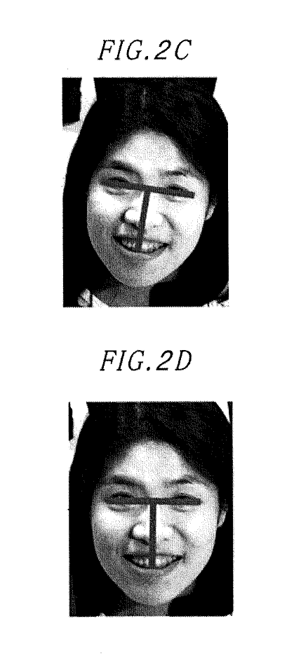

An example in which the face feature information extraction unit 110 extracts face feature information from an input photo will be described with reference to FIGS. 3A to 3C. In case of the input photo as shown in FIG. 3A, that is, the input photo previously corrected by the data processing unit 100, features of eyes, a nose, lips, the line of a jaw, and the like as shown in FIG. 3B are extracted through the machine learning module of the automatic feature recognition unit 111. In order to increase the accuracy of the extracted features, detailed features for a desired portion in the extracted features may be corrected through an interface provided by the user designation feature recognition unit 112 or the composite feature recognition unit 113. For example, after designating a portion of an eye in FIG. 3B, a detailed feature for the designated eye portion is corrected as shown in FIG. 3C.

The 2D avatar generation unit 120 generates a 2D avatar image undergoing an exaggerated and beautified process based on the extracted face feature information. For this, the 2D avatar generation unit 120 includes an avatar exaggeration unit 121 and an avatar beautification unit 122, and the like.

The avatar exaggeration unit 121 generates a unique 2D avatar face based on the face feature information extracted from the input photo. For example, when extracted eye information has a size smaller than an average eye size of people that is previously calculated and stored, the 2D avatar face may be generated by reducing the eye size, or in a similar way, in case where a user has a relatively large nose, the nose may be increased such that an exaggerated image may be automatically generated to make a unique avatar face.

Persons, who have relatively small eyes or large nose, generally consider the small eyes or large nose as their shortcomings. Thus, the avatar beautification unit 122 is applied contrary to the avatar exaggeration unit 121, so that an avatar image can be generated to look attractively.

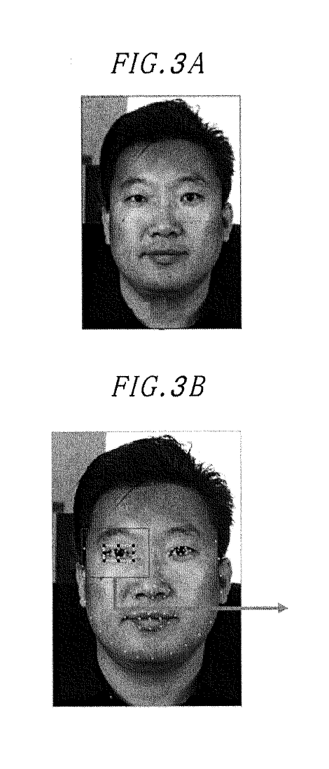

Referring to FIGS. 4A to 4C regarding an example in which the avatar exaggeration unit 121 and the avatar beautification unit 122 generate an avatar image. In case a cheek area in a face photo is greater than an pre-stored average cheek area and an eye size is smaller than a pre-stored average eye as shown in FIG. 4A, the avatar exaggeration unit 121 generates an avatar image on which the cheek area has been even more increased and the eye size has been even smaller to generate an exaggerated face avatar, as shown in FIG. 4B. Or, the avatar beautification unit 122 generates an avatar image on which the cheek area has been reduced and the eye size has been larger as shown in FIG. 4C.

These avatar exaggeration and beautification units 121 and 122 use pre-stored statistic information, i.e., an average cheek area size, an eye size, or the like of people.

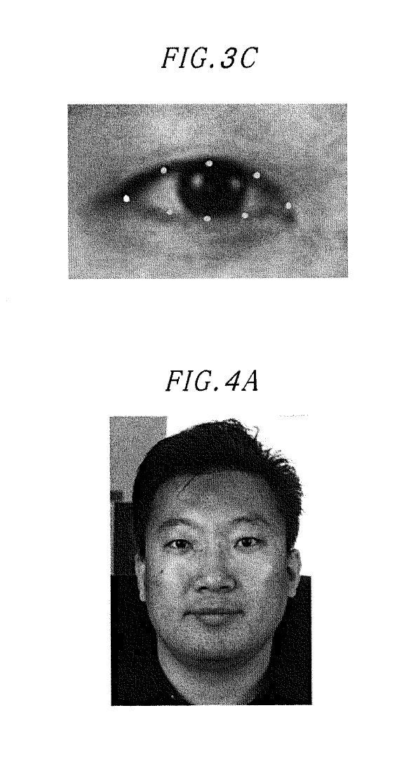

The artistic effect generation unit 130 generates a good-looking avatar image by applying an artistic conversion technique based on the 2D avatar image generated in the 2D avatar generation unit 120. To this end, the artistic effect generation unit 130 includes a cartoon effect processing unit 131, an oil-painting effect processing unit 132, an illustration processing unit 133 and the like. That is, as shown in FIG. 5, the artistic effect generation unit 130 applies artistic effects such as a cartoon, oil-painting and charcoal-drawing to the exaggerated and beautified image output from the 2D avatar generation unit 120 to thus generate a converted image.

The 3D avatar generation unit 140 generates a 3D face mesh resembling the face photo based on feature information extracted from a face portion on the input photo, and generates a 3D avatar image exaggerated or beautified using an input exaggeration or beautification-processed photo depending on a user's setting. In other words, the 3D avatar generation unit 140 may receive the exaggerated or beautified 2D avatar image generated in the artistic effect generation unit 130 to generate an exaggerated or beautified 3D avatar image. Further, when the input photo is not the exaggerated or beautified 2D avatar image, the input photo is exaggerated or beautified through the 3D avatar exaggeration and beautification unit 143 according to an input from the user.

To this end, the 3D avatar generation unit 140 includes a feature difference calculation unit (F.D.C UNIT) 141, a model modification unit 142, a 3D avatar exaggeration and beautification unit (E & B unit) 143, and the like.

The feature difference calculation unit 141 compares predetermined feature information on standard 3D face model (a neutral face model described in the next paragraph) and face feature information received from the face feature information extraction unit 110 to calculate a difference therebetween and provide the calculated result to the model modification unit 142. Herein, the standard information includes predetermined feature vertices among the vertices forming the standard 3D face model.

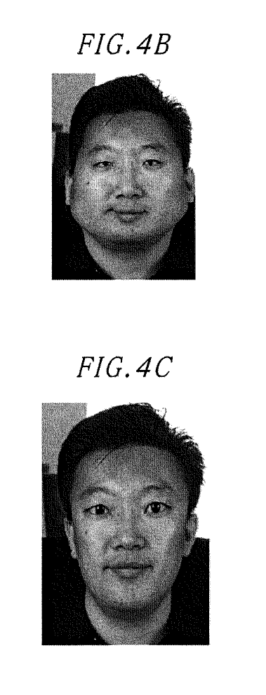

Further, herein, the standard 3D face model is previously generated with a modeling utility, wherein a face model is made first, vertices on the face model corresponding to respective regions in a face are colored to be distinguished with each other and feature vertices are also colored to be distinguish in the respective regions on the face to which the feature vertices belong. The standard 3D face model includes one neutral face model in which respective face regions have medium sizes and eight pairs of face models to represent maximum and minimum size of eight face regions in a pair, e.g., an eye size, a width between eyes, a nose width, a nose length, a mouth size, a thickness of lips, a position of lips, a face contour and the like, as shown in FIG. 6.

The model modification unit 142 modifies the standard 3D face model (neutral face model) based on the calculated feature difference from the feature difference calculation unit 141 to create the 3D face model reflecting the shape of the face in the input photo.

The model modification unit 142 includes a marking processing unit 142a that modifies the standard 3D face model through a user interface and a region control unit 142b that automatically modifies the standard 3D face model based on the calculated feature difference from the feature difference calculation unit 141.

The marking processing unit 142a is optionally operated when the feature information extracted from the face photo is not satisfied or the feature difference calculated from the feature difference calculation unit 141 is erroneous, by a user.

In these cases, marking processing unit 142a compares a face standard model with the feature information extracted from the face photo, and a marking may be performed on vertices constituting a left eye, a right eye, a nose, the line of a jaw, and a contour line of lips. That is, the marking processing unit 142a provides an interface for designating at least one or more vertices among a left eye, a right eye, a nose, the line of a jaw, and a contour line of lips to compare the standard 3D face model with the face feature information.

Further, the marking processing unit 142a provides a user interface for moving a vertex constituting each feature vertex to modify the standard 3D face model. When the vertex forming the feature vertices is moved, face regions are designated to be modified corresponding to the movement of the vertex. Therefore, the marking processing unit 142a provides an interface for offering a control parameter for controlling these face regions to be modified.

Further, the region control unit 142b modifies the standard 3D face model based on the calculated feature difference from the feature difference calculation unit 141 or the control parameter designated from the marking processing unit 142a if it has been generated.

The region control unit 142b divides the standard 3D face model into n regions, and controlling the divided n regions. Herein, the standard 3D face model is modified through control of the n regions to generate the face shape of the face photo.

That is, the region control unit 142b divides the standard 3D face model into, e.g., eight regions and interpolates each face region between maximum and minimum value in the eight pairs of the face models based on calculated feature difference from the feature difference calculation unit 141 or the calculated control parameter, thereby generating a modified standard 3D face model. For example, as shown in FIG. 6, in order to generate a 3D face model (modified standard 3D face model) corresponding to the shape of a face, the region control unit 142b in the model modification unit 142 uses eight pairs of maximum and minimum 3D face models, depending on a face control factor, for example, eight face control factors, and then interpolates each face model of the eight pairs of the face models based on the calculated feature difference or the control parameter, thereby generating a face shape of final face model.

After determining the modification details by the model modification unit 142, the 3D avatar exaggeration and beautification unit 143 finally modifies the standard 3D face model to complete a 3D face model.

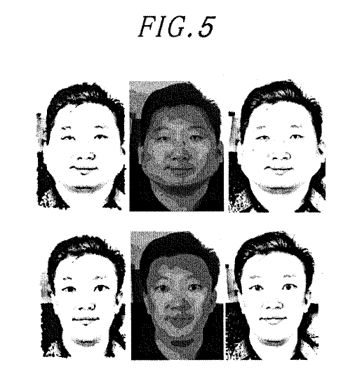

The 3D avatar exaggeration and beautification unit 143 provides an interface for controlling a face feature portion and generate a modified face based on an input of the user through the interface. That is, as shown in FIG. 7A, eight portions may be marked on the face photo, and thereafter, in 3D face model information corresponding thereto, a vertex color may be designated to correspond to each portion thereof so as to provide smoothness in modification, as shown in FIG. 7B.

The 3D avatar utilizing unit 150 gives some effects to a standard 3D face model to utilize a generated 3D avatar, and includes an automatic texture generation unit 151, an avatar model function unit 152 and the like.

The automatic texture generation unit 151 generates a texture of the face in order to provide a realistic feeling to the modified standard 3D face model. That is, the automatic texture generation unit 151 generates a face texture when a realistic feeling from the generated 3D avatar is required. Accordingly, the 3D avatar generation unit 140 generates the 3D avatar image by combining the generated face texture and the modified standard 3D face model.

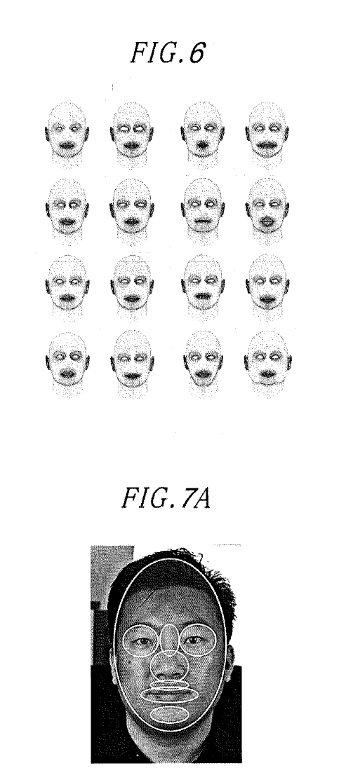

More specifically, a technique for outputting a 3D model to a screen refers to a rendering, and a realistic feeling from a model depends upon a rendering technique. Among several rendering techniques, the most convenient and easy work capable of increasing a realistic feeling is a texture mapping technique. The texture mapping technique is a technique in which a numerical expression or a 2D picture is applied to a surface of a 3D object using several schemes rather than calculating a vertex in a 3D model or brightness in a light source or the like, so that a detailed description can be expressed like an actual object when producing a computer graphic screen. In the embodiment of the present invention, a technique illustrated in FIG. 8 is be used to perform the above-mentioned operation.

In fact, when outputting a 3D model to the screen, the texture mapping technique reads a color of a pixel in a 2D image corresponding to the vertex of the 3D model as the color to be displayed on the screen. At this time, when a position of the vertex is mapped to a position between pixels in the 2D image, the output color value is determined by interpolating the color values of the adjacent pixels in the 2D image. In the embodiment of the present invention, inversely to the above, a 2D texture image 850 is automatically generated based on a previously output 3D scene image 810 as shown in FIG. 8. To this end, a polygonal index file 820 of the standard 3D face model is first generated based on a texture coordinate 800 in the modified standard 3D face model.

Herein, the polygonal index file 820 is provided to store polygon information of the 3D model occupying a texture space on the basis of the standard 3D face model information. In the polygonal index file 820, a space with no color indicates that there is no an allocated 3D polygon, while a portion thereof with a color indicates that a polygonal index value is represented as coloring. In this case, a color T(u, v) value in each coordinate of the texture is determined based on pre-stored polygonal index information 820, and a corresponding coordinates in the 3D scene image 810, i.e., a corresponding coordinates 830, when a polygon was rendered, is traced.

As such, the corresponding coordinates 830 is calculated, and a final texture image, i.e., the 2D texture image 850 is generated by performing a conversion process 840 on a triangle portion in the texture space of the polygonal index file 820 and a triangle 830 within the rendered 3D scene image 810. Here, in the conversion process 840 regarding the triangle portions in the texture space and the triangles 830 within the 3D scene image 810, values of all pixels are determined by a linear interpolation function such that discrete errors due to a difference in a rendering space between the texture space and the 3D scene image 810 can be prevented.

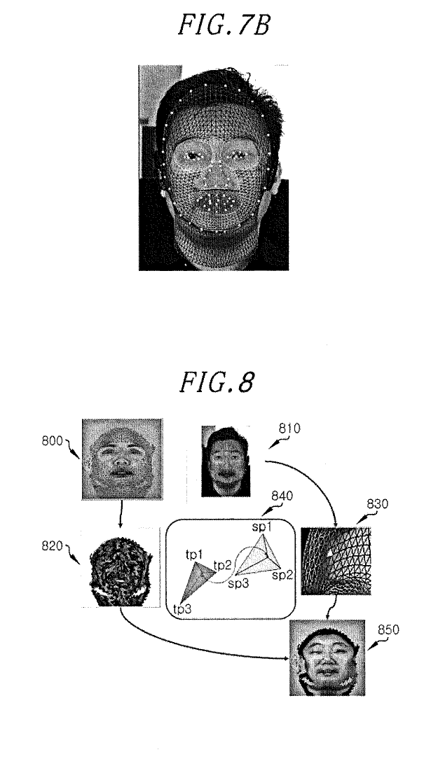

As shown in FIG. 9, finally, a 3D avatar image 930 reflecting the input photo is conveniently generated by using a 3D face model 910 generated by modifying the standard 3D face model input based on the features in the face photo and an automatically generated texture 920.

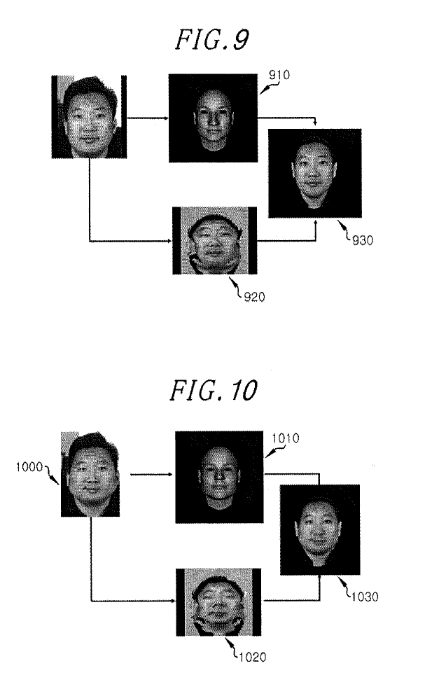

In addition, as shown in FIG. 10, an exaggerated image 1000 is used in the input photo and a 3D avatar image 1030 reflecting the exaggerated image is easily generated by using a 3D face model 1010 by modifying the standard 3D face model based on the exaggerated image 1000 and an automatically generated texture 1020.

The avatar model function unit 152 provides a model exporting function based on the standard document format such that the 3D avatar image and the generated texture are used in other application programs or virtual environments.

In accordance with the embodiment of the present invention, a face avatar generating apparatus is provided, in which 2D and 3D avatars necessary in a cyberspace during using the Internet, a smart phone, or the like may be readily generated, and further, various artistic effects are applied thereto, whereby avatars reflecting a user feature can be created.

In addition, in accordance with the embodiment of the present invention, two forms of, e.g., a 2D model and a 3D model, are created to be suitable for properties in a cyberspace, whereby users may specialize their own avatars in more various cyberspaces.

Moreover, in accordance with the embodiment of the present invention, an avatar may be stored in the standard form and a corresponding avatar may be supported to be shared in different spaces, thereby expecting increased avatar model effects in the cyberspace while maintaining the same avatar in different cyberspaces.

While the invention has been shown and described with respect to the preferred embodiments, it will be understood by those skilled in the art that various changes and modifications may be made without departing from the scope of the invention as defined in the following claims.

What is claimed is:

1. A face avatar generating apparatus comprising:
a face feature information extraction unit for receiving a face photo and extracting face feature information from the face photo;
a two-dimensional (2D) avatar generation unit for selecting at least one region from the face photo based on the face feature information, and exaggerating or beautifying the selected region to create a 2D avatar image; and
a 3D avatar generation unit for modifying a standard 3D face model through a comparison of predetermined feature information on standard 3D face model and the face feature information to create a 3D avatar.

2. The face avatar generating apparatus of claim 1, further comprising:
a data processing unit for correcting geometrical information of the face photo or correcting a color of the face photo.

3. The face avatar generating apparatus of claim 1, wherein the face feature information extraction unit includes a user designation feature recognition unit for designating the feature information by a user through an interface.

4. The face avatar generating apparatus of claim 1, wherein the face feature information extraction unit includes:
an automatic feature recognition unit for designating at least one of both eyes, a nose, lips, and a face contour region on the face photo to extract primary feature information of a face; and
a composite feature recognition unit for providing an interface for correcting the primary feature information, and extracting the primary feature information corrected through the interface as the face feature information.

5. The face avatar generating apparatus of claim 1, wherein the 2D avatar generation unit includes an avatar beautification unit for generating the 2D avatar image by beautifying the predetermined portion on the face photo corresponding to the extracted face feature information based on pre-stored statistic information, or beautifying the predetermined portion based on an input from a user.

6. The face avatar generating apparatus of claim 1, further comprising:
an artistic effect generation unit for applying an artistic conversion technique of at least one of an illustration, a cartoon and an oil painting to the 2D avatar image generated by the 2D avatar generation unit.

7. The face avatar generating apparatus of claim 1, wherein the 3D avatar generation unit includes:
a feature difference calculation unit for comparing the face feature information with predetermined feature information on the standard 3D face model generated based on the pre-stored standard information, to calculate a difference therebetween; and
a model modification unit for modifying the standard 3D model based on the calculated difference, to create the shape of a face on the face photo and then generate the 3D avatar image on the basis of the created face shape.

8. The face avatar generating apparatus of claim 7, wherein the model modification unit includes:
a marking processing unit for providing an interface for designating at least one vertex among a left eye, a right eye, a nose, the line of a jaw, and a contour line of lips in order to compare the standard 3D face model with the face feature information and providing an interface for moving a vertex forming each feature vertex; and
a region control unit for dividing the standard 3D face model into n regions, and controlling the divided n regions, wherein the standard 3D face model is modified through control of the n regions to generate the face shape of the face photo.

9. The face avatar generating apparatus of claim 8, wherein the region control unit interpolates between maximum and minimum value of respective n face regions in n pairs of face models, which has been previously prepared to represent maximum and minimum size of n face regions in a pair, based on calculated feature difference from the feature difference calculation unit or the movement result of the vertex forming each feature vertex.

10. The face avatar generating apparatus of claim 1, further comprising:
3D avatar exaggeration beautification units for exaggerating or beautifying the generated 3D avatar image depending on a user's setting.

11. The face avatar generating apparatus of claim 1, wherein the 3D avatar generation unit includes a texture generation unit for generating a texture of a face of modified standard 3D face model in order to provide a realistic feeling to the modified standard 3D face model, and
the 3D avatar image is created by combining the generated face texture and the modified standard 3D face model.

12. The face avatar generating apparatus of claim 11, wherein the texture generation unit extracts texture information on the face by combining information on the modified standard 3D face model and a 3D scene image including the face photo.

13. The face avatar generating apparatus of claim 11, wherein the texture generation unit generates a polygonal index image based on a texture coordinate in the modified standard 3D face model and then calculates a corresponding coordinates within the 3D scene image when a polygon corresponding to the polygonal index image is rendered, and generates texture information of the face by performing a conversion process on a polygon in a texture coordinates of the polygonal index image and the polygon in the 3D scene image.

14. The face avatar generating apparatus of claim 13, wherein the texture generation unit determines a pixel value using a linear interpolation function in a conversion process on triangle in the texture coordinates and a triangle of the 3D scene image.

15. The face avatar generating apparatus of claim 11, wherein the 3D avatar generation unit further includes an avatar model function unit for providing a model exporting function based on a standard document format to use the 3D avatar image and the generated texture in other application programs or virtual environments.

16. A face avatar generating method comprising:
correcting geometrical information or color information of a face photo received from an outside and extracting face feature information based on the corrected result;
selecting at least one region from the face photo based on the face feature information, and exaggerating or beautifying the selected region to create a 2D avatar image; and
modifying a standard 3D face model through a comparison of predetermined feature information on standard 3D model and the face feature information to create a 3D avatar image.

17. The face avatar generating method of claim 16, wherein said exaggerating or beautifying the selected region includes:
comparing pre-stored statistic information and the extracted face feature information; and
exaggerating or beautifying a predetermined portion on the face photo corresponding to the extracted face feature information based on the comparison result, to create the 2D avatar image.

18. The face avatar generating method of claim 16, wherein said modifying a standard 3D face model includes:
generating the standard 3D face model based on the pre-stored standard information, and comparing feature information of the standard 3D face model with the face feature information to calculate a difference therebetween; and
modifying the standard 3D model based on the calculated difference, to create the shape of a face on the face photo and then generate the 3D avatar image based on the created face shape.

19. The face avatar generating method of claim 18, further comprising:
providing an interface for designating at least one or more vertices among a left eye, a right eye, a nose, a line of a jaw, and a contour line of lips in order to compare the standard 3D face model with the face feature information and providing an interface for moving a vertex forming each feature vertex;
when the vertices designated through the interface are moved, designating n regions moving corresponding to the movement of the vertices, into an n-number of regions; and
modifying the standard 3D face model through control of the n regions to create the shape of a face on the face photo and then generate the 3D avatar image based on the created face shape.
